(19) United States
(12) Patent Application Publication
(10) Pub. No.: US 2019/0281935 A1
(43) Pub. Date: Sep. 19, 2019

(54) Umbrellas, Parasols, Shading Systems, Voice-Activated Hubs and Lighting Systems Utilizing Controller Area Network (CAN) Protocol

(71) Applicant: Shadecraft, Inc., Pasadena, CA (US)

(72) Inventor: Armen Sevada Gharabegian, Glendale, CA (US)

(73) Assignee: Shadecraft, Inc.

(21) Appl. No.: 16/035,635

(22) Filed: Jul. 14, 2018

Related U.S. Application Data
(60) Provisional application No. 62/642,599, filed on Mar. 14, 2018.

(51) Int. Cl. A45B 25/14; G05B 15/02; G10L 15/22; H04W 88/00; H04L 12/40; H04L 12/28

(52) U.S. Cl. CPC A45B 25/143; G05B 15/02; G10L 15/22; H04W 88/00; H04W 4/80; H04L 12/2816; H04L 12/2823; A45B 2200/1027; G10L 2015/223; H04L 12/40006

(57) ABSTRACT

A shading device includes a base assembly, a support assembly, and an expansion assembly, where the expansion assembly to expand one or more arms to an open position or to retract the one or more arms to a closed position. The shading device includes a Bluetooth Low Energy (BLE) transceiver to receive commands or messages from a mobile computing device to activate one or more assemblies of the shading device; one or more Controller Area Network (CAN) transceivers; and a CAN bus to couple the one or more CAN transceivers to the one or more assemblies. The shading device also includes one or more memory devices; one or more processors; computer-readable instructions executable by the one or more processors to: communicate the commands or messages received from the BLE transceiver to the one or more CAN transceivers, the CAN bus and the one or more assemblies.

### RELATED APPLICATIONS

This application claims priority to U.S. provisional patent application Ser. No. 62/642,599, filed Mar. 14, 2018, entitled “Umbrellas, Parasols, Shading Systems, Voice-Activated Hubs and Lighting Systems Utilizing Controller Area Network (CAN) Protocol,” the disclosure of which is incorporated by reference.

### BACKGROUND

Current parasols, umbrellas and shading devices have limited functionality. Outdoor automated umbrellas, parasols or shading devices may also be powered by solar power. However, there may be a limited amount of power available for operations for mechanical and/or electrical operations of the umbrellas and shading devices. Accordingly, a need exists for efficient power utilization in parasols, umbrellas and shading devices. In addition, a need exists for a bus to provide communications between devices, components and assemblies with a shading device.

### BRIEF DESCRIPTION OF DRAWINGS

FIGS. 1A, 1B and 1C illustrate a modular umbrella shading system according to embodiments;

FIG. 2A illustrates a block diagram of power distribution via a CAN bus in a shading device;

FIG. 2B illustrates a block diagram and data flow diagram of a shading device include a CAN bus according to embodiments;

FIG. 3 illustrates a block diagram of components or assemblies of a shading device according to embodiments;

FIG. 4A illustrates a mechanical view of a shading system including a plurality of physical enclosures connected or coupled via a Controller Area Network (CAN) bus according to embodiments;

FIG. 4B illustrates a physical enclosure housing a component, system, assembly, device or printed circuit board according to embodiments; and

FIG. 5 illustrates a block diagram of a misting system in a shading device according to embodiments

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

Also as used herein, one or more parameters may be descriptive of a collection of signal samples, such as one or more electronic documents, and exist in the form of physical signals and/or physical states, such as memory states. For example, one or more parameters may include parameters, such as 1) how much an assembly (e.g., motor assembly) may move or be requested to move; 2) a time of day at which an image was captured, a latitude and longitude of an image capture device, such as a camera; 3) time and day of when a sensor reading (e.g., humidity, temperature, air quality, UV radiation) may be received and/or measurements or values of sensor readings; and/or 4) operating conditions of one or more motors or other components or assemblies in a shading device. Claimed subject matter is intended to embrace meaningful, descriptive parameters in any format, so long as the one or more parameters comprise physical signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a modular umbrella shading system may comprise a computing device installed within or as part of a modular umbrella system, intelligent umbrella and/or intelligent shading charging system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a balcony shading and power system processor, controller and/or computing device). In the context of this specification, therefore, a special purpose computer or a similar special purpose electronic computing device (e.g., a balcony shading and power system processor, controller and/or computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., a balcony shading and power system processor, controller and/or computing device or single board computers, and various other electronic and mechanical devices coupled thereto or installed thereon. Microcontrollers may include processors, microprocessors, and other electronic components. Controller may be a commercially available processor such as an Intel Pentium, Raspberry Pi, other Linux-based computers, Motorola PowerPC, SGI MIPS, Sun UltraSPARC, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. In embodiments, a processor and/or controller may be connected to other devices also via power buses from either a rechargeable power source and/or a solar charging assembly. Usually, a processor or controller, may execute an operating system which may be, for example, a Windows-based operating system (Microsoft), a MAC OS System X operating system (Apple Computer), one of many Linux-based operating system distributions, a portable electronic device operating system (e.g., mobile phone operating systems), microcomputer operating systems, and/or a UNIX operating systems. Embodiments are not limited to any particular implementation and/or operating system.

The specification may refer to an umbrella, a robotic shading device, a shading device, or a parasol. In embodiments, each of these devices may be intelligent and/or automated. In embodiments, these may be standalone or free-standing devices. In embodiments, an umbrella, robotic shading system, shading device or a parasol may provide shade and/or coverage to a user from weather elements such as sun, wind, rain, and/or hail in an outdoor environment or outdoor portions of a structure (whether building, office and/or sports complexes). In embodiments, an umbrella, a robotic shading device, shading device or a parasol may be an automated, intelligent and/or employ artificial intelligence and/or machine learning. The device and/or apparatus may also be referred to as a sun shade, outdoor shade furniture, sun screen, sun shelter, awning, sun cover, sun marquee, brolly and other similar names, which may all be utilized interchangeably in this application.

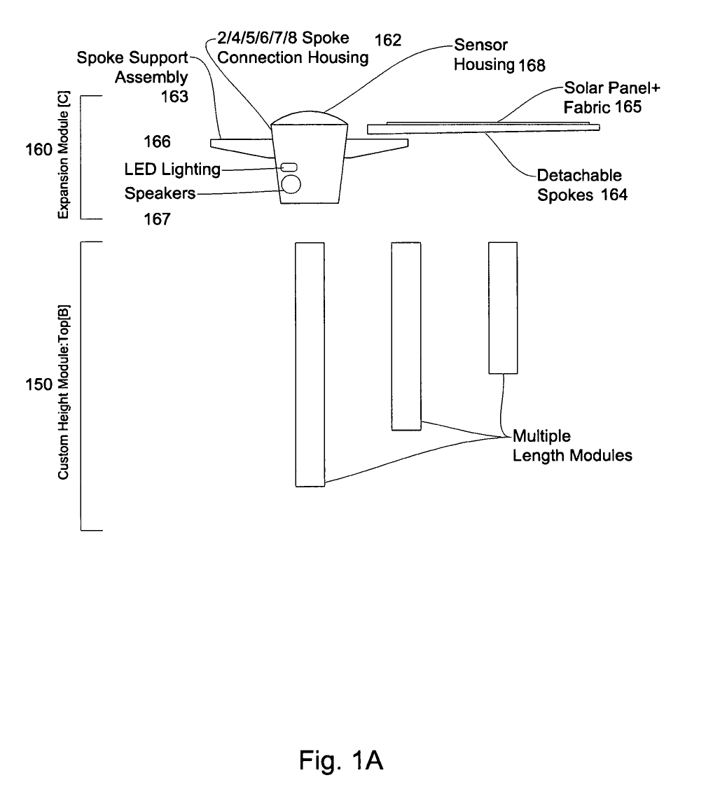

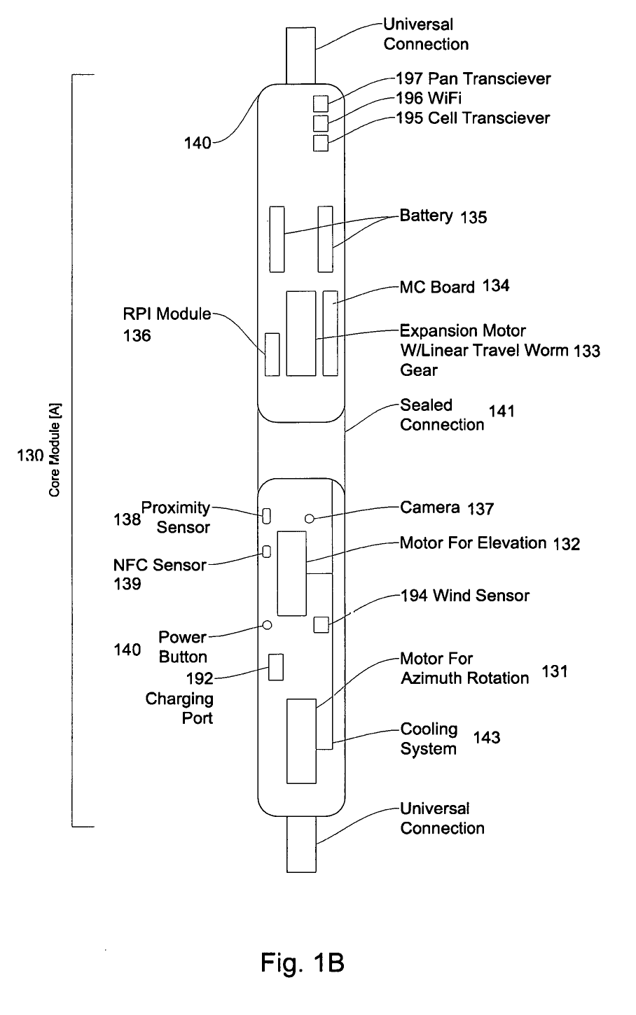

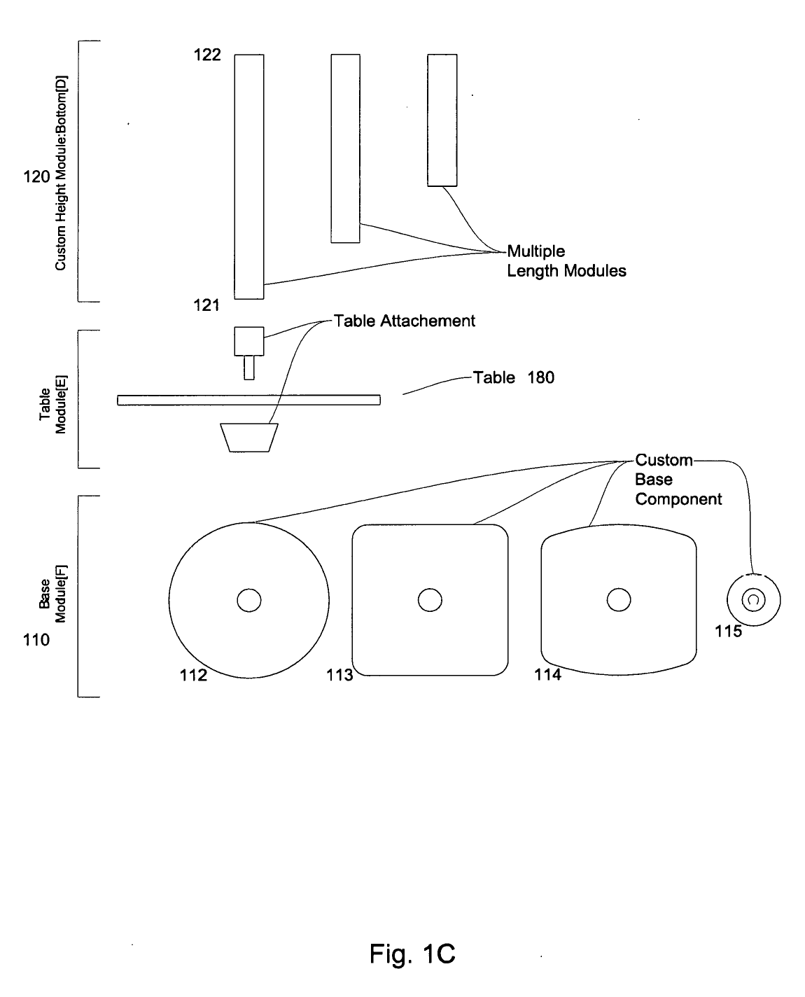

FIGS. 1A, 1B and 1C illustrate a modular umbrella shading system according to embodiments. In embodiments, a modular umbrella system 100 comprises a base assembly or module 110, a first extension assembly or module 120, a core assembly module housing (or core umbrella assembly) 130, a second extension assembly or module 150, and an expansion sensor assembly or module (or an arm extension assembly or module) 160. In embodiments, a modular umbrella shading system 100 may not comprise a base assembly or module 110 and may comprise a table assembly or module 180 to connect to table tops, such as patio tables and/or other outdoor furniture. In embodiments, a table assembly or module 180 may comprise a table attachment and/or a table receptacle. In embodiments, a base module or assembly 110 may comprise a circular base component 112, a square or rectangular base component 113, a rounded edges base component 114, and/or a beach or sand base component 115. In embodiments, base components 112, 113, 114, and/or 115 may be interchangeable based upon a configuration required by an umbrella system and/or user. In embodiments, each of the different options for the base components 112, 113, 114, 115, and/or 180 may have a universal connector and/or receptacle to allow for easy interchangeability.

In embodiments, a first extension assembly or module 120 may comprise a shaft assembly having a first end 121 and a second end 122. In embodiments, a first end 121 may be detachably connectable and/or connected to a base assembly or module 110. In embodiments, a second end 122 may be detachably connected and/or connectable to a first end of a core umbrella assembly or module 130. In embodiments, a first end 121 and a second end 122 may have a universal umbrella connector. In other words, a connector may be universal within all modules and/or assemblies of a modular umbrella system to provide a benefit of allowing backwards capabilities with new versions of different modules and/or assemblies of a modular umbrella shading system. In embodiments, a first extension assembly or module 120 may have different lengths. In embodiments, different length first extension assemblies may allow a modular umbrella shading system to have different clearance heights between a base assembly or module 110 and/or a core umbrella assembly or module 130. In embodiments, a first extension assembly or module 110 may be a tube and/or a shell with channels, grooves and/or pathways for electrical wires and/or components and/or mechanical components. In embodiments, a first extension assembly 110 may be a shaft assembly having an inner core comprising channels, grooves and/or pathways for electrical wires, connectors and/or components and/or mechanical components.

In embodiments, a universal umbrella connector or connection assembly 124 may refer to a connection pair and/or connection assembly that may be uniform for all modules, components and/or assemblies of a modular umbrella system 100. In embodiments, having a universal umbrella connector or connection assembly 124 may allow interchangeability and/or backward compatibility of the various assemblies and/or modules of the modular umbrella system 100. In embodiments, for example, a diameter of all or most of universal connectors 124 utilized in a modular umbrella system may be the same. In embodiments, a universal connector or connection assembly 124 may be a twist-on connector. In embodiments, a universal connector 124 may be a drop in connector and/or a locking connector, having a male and female connector. In embodiments, a universal connector or connection assembly 124 may be a plug with another connector being a receptacle. In embodiments, universal connector 124 may be an interlocking plug receptacle combination. For example, universal connector 124 may be a plug and receptacle, jack and plug, flanges for connection, threaded plugs and threaded receptacles, snap fit connectors, adhesive or friction connectors. In embodiments, for example, universal connector or connection assembly 124 may be external connectors engaged with threaded internal connections, snap-fit connectors, push fit couplers. In embodiments, by having a universal connector or connection assembly 124 for joints or connections between a base module or assembly 110 and a first extension module or assembly 120, a first extension module or assembly 120 and a core assembly module or assembly 130, a core assembly module or assembly 130 and a second extension module or assembly 150, and/or a second extension module or assembly 150 and an expansion sensor module or assembly 160, an umbrella or shading object manufacturer may not need to provide additional parts for additional connectors for attaching, coupling or connecting different modules or assemblies of a modular umbrella shading system. In addition, modules and/or assemblies may be upgraded easily because one module and/or assembly may be switched out of a modular umbrella system without having to purchase or procure additional modules because of the interoperability and/or interchangeability.

In embodiments, a core umbrella assembly or module 130 may be positioned between a first extension assembly or module 120 and a second extension assembly or module 150. In embodiments, core umbrella assembly or module 130 may be positioned between a base assembly or module 110 and/or an expansion and sensor module or assembly 160. In embodiments, a core umbrella assembly or module 130 may comprise an upper core assembly 140, a core assembly connector or mid-section 141 and/or a lower core assembly 142. In embodiments, a core assembly connector 141 may be a sealer or sealed connection to protect a modular umbrella system from environmental conditions. In embodiments, a core umbrella assembly or module 130 may comprise two or more motors or motor assemblies. Although the specification may refer to a motor, a motor may be a motor assembly with a motor controller, a motor, a stator, a rotor and/or a drive/output shaft. In embodiments, a core umbrella assembly 130 may comprise an azimuth rotation motor 131, an elevation motor 132, and/or a spoke expansion/retraction motor 133. In embodiments, an azimuth rotation motor 131 may cause a core umbrella assembly 130 to rotate clockwise or counterclockwise about a base assembly or module 110 or a table connection assembly 180. In embodiments, an azimuth rotation motor 131 may cause a core umbrella assembly 130 to rotate about an azimuth axis. In embodiments, a core umbrella assembly or module 130 may rotate up to 360 degrees with respect to a base assembly or module 130.

In embodiments, an elevation motor 132 may cause an upper core assembly 140 to rotate with respect to a lower core assembly 142. In embodiments, an elevation motor 130 may rotate an upper core assembly 140 between 0 to 90 degrees with respect to the lower core assembly 142. In embodiments, an elevation motor 130 may rotate an upper module or assembly 140 between 0 to 30 degrees with respect to a lower assembly or module 142. In embodiments, an original position may be where an upper core assembly 140 is positioned in line and above the lower core assembly 142, as is illustrated in FIGS. 1A, 1B and 1C.

In embodiments, a spoke expansion motor 133 may be connected to an expansion and sensor assembly module 160 via a second extension assembly or module 150 and cause spoke or arm support assemblies in a spoke expansion sensor assembly module 160 to deploy or retract outward and/or upward from an expansion sensor assembly module 160. In embodiments, an expansion extension assembly module 160 may comprise a rack gear and spoke connector assemblies (or arms). In embodiments, a spoke expansion motor 133 may be coupled and/or connected to a hollow tube via a gearing assembly, and may cause a hollow tube to move up or down (e.g., in a vertical direction). In embodiments, a hollow tube may be connected and/or coupled to a rack gear, which may be connected and/or coupled to spoke connector assemblies. In embodiments, movement of a hollow tube in a vertical direction may cause spoke assemblies and/or arms to be deployed and/or retracted. In embodiments, spoke connector assemblies and/or arms may have a corresponding and/or associated gear at a vertical rack gear.

In embodiments, a core assembly or module 130 may comprise motor control circuitry 134 (e.g., a motion control board 134) that controls operation of an azimuth motor 131, an elevation motor 132 and/or an expansion motor 133, along with other components and/or assemblies. In embodiments, the core assembly module 130 may comprise one or more batteries 135 (e.g., rechargeable batteries) for providing power to electrical and mechanical components in the modular umbrella system 100. For example, one or more batteries 135 may provide power to motion control circuitry 134, an azimuth motor 131, an expansion motor 133, an elevation motor 132, a camera 137, a proximity sensor 138, a near field communication (NFC) sensor 138. In embodiments, one or more batteries 135 may provide power to an integrated computing device 136, although in other embodiments, an integrated computing device 136 may also comprise its own battery (e.g., rechargeable battery).

In embodiments, the core assembly 130 may comprise a separate and/or integrated computing device 136. In embodiments, a separate computing device 136 may comprise a Raspberry Pi computing device, other single-board computers and/or single-board computing device. Because a modular umbrella shading system has a limited amount of space, a single-board computing device is a solution that allows for increased functionality without taking up too much space in an interior of a modular umbrella shading system. In embodiments, a separate computing device 136 may handle video, audio and/or image editing, processing, and/or storage for a modular umbrella shading system 100 (which are more data intensive functions and thus require more processing bandwidth and/or power). In embodiments, an upper core assembly 140 may comprise one or more rechargeable batteries 135, a motion control board (or motion control circuitry) 134, a spoke expansion motor 133 and/or a separate and/or integrated computing device 136.

In embodiments, a core assembly connector/cover 141 may cover and/or secure a connector between an upper core assembly 140 and a lower core assembly 142. In embodiments, a core assembly connector and/or cover 141 may provide protection from water and/or other environmental conditions. In other words, a core assembly connector and/or cover 141 may make a core assembly 130 waterproof and/or water resistant and in other environments, may protect an interior of a core assembly from sunlight, cold or hot temperatures, humidity and/or smoke. In embodiments, a core assembly connector/cover 141 may be comprised of a rubber material, although a plastic and/or fiberglass material may be utilized. In embodiments, a core assembly connector/cover 141 may be comprised of a flexible material, silicone, and/or a membrane In embodiments, a core assembly connector/cover 141 may be circular and/or oval in shape and may have an opening in a middle to allow assemblies and/or components to pass freely through an interior of a core assembly connector or cover 141. In embodiments, a core assembly connector/cover 141 may adhere to an outside surface of an upper core assembly 140 and a lower core assembly 142. In embodiments, a core assembly connector/cover 141 may be connected, coupled, fastened and/or have a grip or to an outside surface of the upper core assembly 140 and the lower core assembly 142. In embodiments, a core assembly connector and/or cover 141 may be connected, coupled, adhered and/or fastened to a surface (e.g., top or bottom surface) of an upper core assembly and/or lower core assembly 142. In embodiments, a core assembly connector/cover 141 may cover a hinging assembly and/or reparation point, springs, and wires that are present between an upper core assembly 140 and/or a lower core assembly 142.

In embodiments, a core assembly or module 130 may comprise one or more cameras 137. In embodiments, one or more cameras 137 may be capture images, videos and/or sound of an area and/or environment surrounding a modular umbrella system 100. In embodiments, a lower core assembly 142 may comprise one or more cameras 137. In embodiments, a camera 137 may only capture sound if a user selects a sound capture mode on a modular umbrella system 100 (e.g., via a button and/or switch) or via a software application controlling operation of a modular umbrella system (e.g., a microphone or recording icon is selected in a modular umbrella system software application).

In embodiments, a core assembly 130 may comprise a power button to manually turn on or off power to components of a modular umbrella system. In embodiments, a core assembly or module 130 may comprise one or more proximity sensors 138. In embodiments, one or more proximity sensors 138 may detect whether or not an individual and/or subject may be within a known distance from a modular umbrella system 100. In embodiments, in response to a detection of proximity of an individual and/or subject, a proximity sensor 138 may communicate a signal, instruction, message and/or command to motion control circuitry (e.g., a motion control PCB 134) and/or a computing device 136 to activate and/or deactivate assemblies and components of a modular umbrella system 100. In embodiments, a lower core assembly 142 may comprise a proximity sensor 138 and a power button. For example, a proximity sensor 138 may detect whether an object is within proximity of a modular umbrella system and may communicate a message to a motion control PCB 134 to instruct an azimuth motor 131 to stop rotating a base assembly or module.

In embodiments, a core assembly or module 130 may comprise a near-field communication (NFC) sensor 139. In embodiments, a NFC sensor 139 may be utilized to identify authorized users of a modular umbrella shading system 100. In embodiments, for example, a user may have a mobile computing device with a NFC sensor which may communicate, pair and/or authenticate in combination with a modular umbrella system NFC sensor 139 to provide user identification information. In embodiments, a NFC sensor 139 may communicate and/or transmit a signal, message, command and/or instruction based on a user's identification information to computer-readable instructions resident within a computing device and/or other memory of a modular umbrella system to verify a user is authenticated and/or authorized to utilize a modular umbrella system 100.

In embodiments, a core assembly or module 130 may comprise a cooling system and/or heat dissipation system 143. In embodiments, a cooling system 143 may be one or more channels in an interior of a core assembly or module 130 that direct air flow from outside a modular umbrella system across components, motors, circuits and/or assembles inside a core assembly 130. For example, one or more channels and/or fins may be coupled and/or attached to components, motors and/or circuits, and air may flow through channels to fins and/or components, motors and/or circuits. In embodiments, a cooling system 143 may lower operating temperatures of components, motors, circuits and/or assemblies of a modular umbrella system 100. In embodiments, a cooling system 143 may also comprise one or more plates and/or fins attached to circuits, components and/or assemblies and also attached to channels to lower internal operating temperatures. In embodiments, a cooling system 143 may also move hot air from electrical and/or mechanical assemblies to outside a core assembly. In embodiments, a cooling system 143 may be fins attached to or vents in a body of a core assembly 130. In embodiments, fins and/or vents of a cooling system 143 may dissipate heat from electrical and mechanical components and/or assemblies of the core module or assembly 130.

In embodiments, a separate, detachable and/or connectable skin may be attached, coupled, adhered and/or connected to a core module assembly 130. In embodiments, a detachable and/or connectable skin may provide additional protection for a core assembly module against water, smoke, wind and/or other environmental conditions and/or factors. In embodiments, a skin may adhere to an outer surface of a core assembly.130. In embodiments, a skin may have a connector on an inside surface of the skin and core assembly 130 may have a mating receptacle on an outside surface. In embodiments, a skin may magnetically couple to a core assembly 130. In embodiments, a skin may be detachable and removable from a core assembly so that a skin may be changed for different environmental conditions and/or factors. In embodiments, a skin may connect to an entire core assembly. In embodiments, a skin may connect to portions of an upper core assembly 140 and/or a lower core assembly 142. In embodiments, a skin may not connect to a middle portion of a core assembly 130 (or a core assembly cover connector 141). In embodiments, a skin may be made of a flexible material to allow for bending of a modular umbrella system 100. In embodiments, a base assembly 110, a first extension assembly 120, a core module assembly 130, a second extension assembly 140 and/or an arm extension and sensor assembly 160 may also comprise one or more skin assemblies. In embodiments, a skin assembly may provide a cover for a majority of all of a surface area one or more of the base assembly, first extension assembly 120, core module assembly 130, second extension assembly 150 and/or arm extension sensor assembly 160. In embodiments, a core assembly module 130 may further comprise channels on an outside surface. In embodiments, a skin assembly may comprise two pieces. In embodiments, a skin assembly may comprise edges and/or ledges. In embodiments, edges and/or ledges of a skin assembly may be slid into channels of a core assembly module 130. In embodiments, a base assembly 110, a first extension assembly 120, a second extension assembly 140 and/or an arm expansion sensor assembly 160 may also comprise an outer skin assembly. In embodiments, skin assemblies for these assemblies may be uniform to present a common industrial design. In embodiments, skin assemblies may be different if such as a configuration is desired by a user. In embodiments, skin assemblies may be comprise of a plastic, a hard plastic, fiberglass, aluminum, other light metals (including aluminum), and/or composite materials including metals, plastic, wood. In embodiments, a core assembly module 130, a first extension assembly 120, a second extension assembly 150, an arm expansion sensor assembly 160, and/or a base assembly 110 may be comprised of aluminum, light metals, plastic, hard plastics, foam materials, and/or composite materials including metals, plastic, wood. In embodiments, a skin assembly may be provide protection from environmental conditions (such as sun, rain, and/or wind).

In embodiments, a second extension assembly 150 connects and/or couples a core assembly module 130 to an expansion assembly sensor module (and/or arm extension assembly module) 160. In embodiments, an expansion sensor assembly module 160 may have universal connectors and/or receptacles on both ends to connect or couple to universal receptacles and/or connectors, on the core assembly 130 and/or expansion sensor assembly module 160. FIGS. 1A, 1B, and 1C illustrate that a second extension assembly or module 150 may have three lengths. In embodiments, a second extension assembly 150 may have one of a plurality of lengths depending on how much clearance a user and/or owner may like to have between a core assembly module 130 and spokes of an expansion sensor assembly or module 160. In embodiments, a second extension assembly or module 150 may comprise a hollow tube and/or channels for wires and/or other components that pass through the second extension assembly or module 150. In embodiments, a hollow tube 249 may be coupled, connected and/or fixed to a nut that is connected to, for example, a threaded rod (which is part of an expansion motor assembly). In embodiments, a hollow tube 249 may be moved up and down based on movement of the threaded rod. In embodiments, a hollow tube in a second extension assembly may be replaced by a shaft and/or rod assembly.

In embodiments, an expansion and sensor module 160 may be connected and/or coupled to a second extension assembly or module 150. In embodiments, an expansion and sensor assembly or module 160 may be connected and/or coupled to a second extension assembly or module 150 via a universal connector. In embodiments, an expansion and sensor assembly or module 160 may comprise an arm or spoke expansion sensor assembly 162 and a sensor assembly housing 168. In embodiments, an expansion and sensor assembly or module 160 may be connected to a hollow tube 249 and thus coupled to a threaded rod. In embodiments, when a hollow tube moves up and down, an arm or spoke expansion assembly 162 opens and/or retracts, which causes spokes/blades 164 of an arm extension assembly 163. In embodiments, arms, spokes and/or blades 164 may detachably connected to the arm or spoke support assemblies 163.

In embodiments, an expansion and sensor assembly module 160 may have a plurality of arms, spokes or blades 164 (which may be detachable or removable). Because the umbrella system is modular and/or adjustable to meet needs of user and/or environment, an arm or spoke expansion assembly 162 may not have a set number of arm, blade or spoke support assemblies 163. In embodiments, a user and/or owner may determine and/or configure a modular umbrella system 100 with a number or arms, spokes, or blades extensions 163 (and thus detachable spokes, arms and/or blades 164) necessary for a certain function and attach, couple and/or connect an expansion sensor assembly or module 160 with a spoke expansion assembly 162 with a desired number of blades, arms or spoke connections to a second extension module or assembly 150 and/or a core module assembly or housing 130. Prior umbrellas or shading systems utilize a set or established number of ribs and were not adjustable or configurable. In contrast, a modular umbrella system 100 described herein has an ability to have a detachable and adjustable expansion sensor module 162 comprising an adjustable number of arm/spoke/blade support assemblies or connections 163 (and therefore a flexible and adjustable number of arms/spokes/blades 164), which provides a user with multiple options in providing shade and/or protection. In embodiments, expansion and sensor expansion module 160 may be detachable or removable from a second extension module 150 and/or a core assembly module 130 and also one or more spokes, arms and/or assemblies 164 may be detachable or removable from arm or spoke support assemblies 163. Therefore, depending on the application or use, a user, operator and/or owner may detachably remove an expansion and sensor module or assembly 160 having a first number of arm/blade/spoke support assemblies 163 and replace it with a different expansion sensor module or assembly 160 having a different number of arm/blade/spoke support assemblies 163.

In embodiments, arms, blades and/or spokes 164 may be detachably connected and/or removable from one or more arm support assemblies 163. In embodiments, arms, blades, and/or spokes 164 may be snapped, adhered, coupled and/or connected to associated arm support assemblies 163. In embodiments, arms, blades and/or spokes 164 may be detached, attached and/or removed before deployment of the arm extension assemblies 163.

In embodiments, a shading fabric 165 may be connected, attached and/or adhered to one or more arm extension assemblies 163 and provide shade for an area surrounding, below and/or adjacent to a modular umbrella system 100. In embodiments, a shading fabric (or multiple shading fabrics) may be connected, attached, and/or adhered to one or more spokes, arms and/or blades 164. In embodiments, a shading fabric or covering 165 may have integrated therein, one or more solar panels and/or cells (not shown). In embodiments, solar panels and/or cells may generate electricity and convert the energy from a solar power source to electricity. In embodiments, solar panels may be coupled to a shading power charging system (not shown). In embodiments, one or more solar panels and/or cells may be positioned on top of a shading fabric 165. In embodiments, one or more solar panels and/or cells may be connected, adhered, positioned, attached on and/or placed on a shading fabric 165.

In embodiments, an expansion sensor assembly or module 160 may comprise one or more audio speakers 167. In embodiments, an expansion sensor assembly or module 160 may further comprise an audio/video transceiver. In embodiments, a core assembly 130 may comprise and/or house an audio/video transceiver (e.g., a Bluetooth or other PAN transceiver, such as Bluetooth transceiver 197). In embodiments, an expansion sensor assembly or module 160 may comprise an audio/video transceiver (e.g., a Bluetooth and/or PAN transceiver) In embodiments, an audio/video transceiver in an expansion sensor assembly or module 160 may receive audio signals from an audio/video transceiver 197 in a core assembly 130, convert to an electrical audio signal and reproduce the sound on one or more audio speakers 167, which projects sound in an outward and/or downward fashion from a modular umbrella system 100. In embodiments, one or more audio speakers 167 may be positioned and/or integrated around a circumference of an expansion sensor assembly or module 160.

In embodiments, an expansion sensor assembly or module 160 may comprise one or more LED lighting assemblies 166. In embodiments, one or more LED lighting assemblies 166 may comprise bulbs and/or LED lights and/or a light driver and/or ballast. In embodiments, an expansion sensor assembly or module 160 may comprise one or more LED lighting assemblies positioned around an outer surface of the expansion sensor assembly or module 160. In embodiments, one or more LED lighting assemblies 166 may drive one or more lights. In embodiments, a light driver may receive a signal from a controller or a processor in a modular umbrella system 100 to activate/deactivate LED lights. The LED lights may project light into an area surrounding a modular umbrella system 100. In embodiments, one or more lighting assemblies 166 may be recessed into an expansion or sensor module or assembly 160.

In embodiments, an arm expansion sensor housing or module 160 may also comprise a sensor housing 168. In embodiments, a sensor housing 168 may comprise one or more environmental sensors, one or more telemetry sensors, and/or a sensor housing cover. In embodiments, one or more environmental sensors may comprise one or more air quality sensors, one or more UV radiation sensors, one or more digital barometer sensors, one or more temperature sensors, one or more humidity sensors, one or more carbon monoxide sensors, one or more carbon dioxide sensors, one or more gas sensors, one or more radiation sensors, one or more interference sensors, one or more lightning sensors, one or more and/or one or more wind speed sensors. In embodiments, one or more telemetry sensors may comprise a GPS/GNSS sensor and/or one or more digital compass sensors. In embodiments, a sensor housing 168 may also comprise one or more accelerometers and/or one or more gyroscopes. In embodiments, a sensor housing 168 may comprise sensor printed circuit boards and/or a sensor cover (which may or may not be transparent). In embodiments, a sensor printed circuit board may communicate with one or more environmental sensors and/or one or more telemetry sensors (e.g., receive measurements and/or raw data), process the measurements and/or raw data and communicate sensor measurements and/or data to a motion control printed circuit board (e.g., controller) and/or a computing device (e.g., controller and/or processor). In embodiments, a sensor housing 168 may be detachably connected to an arm connection housing/spoke connection housing to allow for different combinations of sensors to be utilized for different umbrellas. In embodiments, a sensor cover of a sensor housing 168 may be clear and/or transparent to allow for sensors to be protected from an environment around a modular umbrella system. In embodiments, a sensor cover may be moved and/or opened to allow for sensors (e.g., air quality sensors to obtain more accurate measurements and/or readings). In embodiments, a sensor printed circuit board may comprise environmental sensors, telemetry sensors, accelerometers, gyroscopes, processors, memory, and/or controllers in order to allow a sensor printed circuit board to receive measurements and/or readings from sensors, process received sensor measurements and/or readings, analyze sensor measurements and/or readings and/or communicate sensor measurements and/or readings to processors and/or controllers in a core assembly or module 130 of a modular umbrella system 100.

In embodiments, a modular umbrella shading system 100 may comprise a lightning sensor. In embodiments, a lightning sensor may be installed on a base assembly 110. In embodiments, a lightning sensor may be installed on a core module or core assembly 130. In embodiments, a lightning sensor may be installed on a sensor and/or expansion assembly or module 160. In embodiments, a lightning sensor may be installed, attached, fastened and/or positioned on a shading fabric, an arm, and/or a blade of an intelligent shading system. In embodiments, a lightning sensor may be installed on and/or within a sensor housing 168. In embodiments, a lightning sensor may be installed on and/or connected, adhered or coupled to a skin of an intelligent umbrella and/or shading system. In embodiments, a lightning sensor may detect lightning conditions around an area or in a vicinity of an intelligent umbrella and/or shading system. In embodiments, a lightning sensor may detect an interference signal strength and/or pattern in an atmosphere that corresponds to either intra-cloud lightning conditions and/or occurrences, and/or to cloud-to-ground lightning conditions and/or occurrences. In embodiments, a lightning sensor may have tolerance conditions set. In embodiments, a lightning sensor may also able to measure and/or calculate a distance from a location with an intelligent shading system and/or intelligent umbrella to a location where a lightning event and/or condition has occurred. In embodiments, a lightning sensor may be an Austria Microsystems Franklin AS3935 digital lightning sensor. In embodiments, a lightning sensor may calculate signal measurements, signal strengths, other conditions (e.g., based at least on interference received with respect to lightning conditions) and/or distances, and may communicate signal measurements, signal strengths, other conditions and/or distances to a memory in an intelligent umbrella for storage. In embodiments, lightning sensor signal measurements, strengths, conditions and/or distances may be communicated to a computing device 136 where one or more processors may execute computer-readable instructions to 1) receive lightning sensor signal measurements, strength measurements, conditions and/or distances, 2) process such measurements and/or conditions; and 3) generate commands, instructions, messages and/or signals to cause actions by other components and/or assemblies in an intelligent umbrella and/or robotic shading system in response to measurements and/or conditions captured and/or received by a lightning sensor. In embodiments, computer-readable instructions fetched from one or more memory modules and executed by a processor of a computing device 136 may generate and communicate commands to a motion control board 134 to cause different motor assemblies to move assemblies (e.g., an upper portion of a core assembly and/or are support assemblies to extend arms) of an intelligent umbrella and/or shading system. In embodiments, because portions of an intelligent umbrella and/or shading system are metallic, computer-readable instructions executed by one or more processors may generate and communicate commands, messages, signals or instructions to cause an expansion and sensor assembly 160 to retract arms and/or spokes 164 to a rest or closed position and/or to turn off other sensors in a sensor housing to protect sensors from lightning strikes. In embodiments, because portions of an intelligent umbrella and/or shading system are metallic and conductive, computer-readable instructions executed by one or more processors may generate and communicate commands, messages, signals or instructions to cause an expansion and sensor assembly 160, a core assembly 130 and/or a base assembly to turn off or deactivate other components, motors, processors and/or sensors to prevent damage from electrical (voltage and/or current surges) in a sensor housing to protect sensors from lightning strikes. In embodiments, computer-readable instructions executed by a processor of a computing device 136 (or other processor/controller) may generate and communicate commands, messages, signals and/or instructions to a sound reproduction system (e.g., an audio receiver and/or speaker) to cause an alarm to be activated and/or a warning message to be reproduced and/or generate and communicate commands, messages, signals and/or instructions to a lighting system 166 to generate lights and/or rays indicating a dangerous situation is occurring or going to occur. In addition, because lightning strikes can damage electrical components, a lightning sensor's measurements, conditions and/or distances may be communicated to a processor and computer-readable instructions executed by one or more processors may generate and communicate commands to a power subsystem (e.g., a rechargeable battery and/or power charging assembly) to power off an intelligent umbrella and/or shading system 100 and/or to power off and/or deactivate components and/or assemblies susceptible to lightning strikes and large voltage and/or current surges associated therewith. Advantages of having a lightning sensor integrated within an intelligent umbrella and/or shading system 100 and/or attached, connected or coupled thereto, are that a lightning sensor may identify dangerous conditions, shut down portions of an intelligent umbrella and/or shading system and warn users of a potentially damaging and dangerous situation when a user or operator may not be aware such dangerous conditions are present.

In embodiments, a modular umbrella shading system 100 may comprise an interference sensor (e.g., a noise sensor and/or a wireless noise or interference sensor or scanner). In embodiments, such an interference sensor may identify sources and strengths of noise and/or interference in a vicinity of an intelligent umbrella and/or robotic shading system 100. For example, interference and/or noise may be radio frequency interference, electromagnetic interference, randomly generated noise, impulse noise, acoustic noise, thermal noise, etc. For example, noise and/or interference may be present in certain wireless communication spectrum bands. In embodiments, an interference sensor may be installed or located on a base assembly 110. In embodiments, an interference sensor may be installed or located on a core module or core assembly 130. In embodiments, an interference sensor may be installed or located on a sensor and/or expansion assembly or module 160. In embodiments, an interference sensor may be installed, position, attached, and/or connected to a shading fabric, an arm support assembly and/or an arm or blade of an intelligent umbrella. In embodiments, an interference sensor may be installed on and/or within a sensor housing 168. In embodiments, a lightning sensor may be installed on and/or connected, adhered or coupled to a skin of an intelligent umbrella and/or shading system. In embodiments, an interference sensor may detect noise and/or interference conditions around or in a vicinity of an intelligent umbrella and/or shading system. In embodiments, an interference sensor may detect and/or measure an interference signal strength (e.g., interference that may impact operations of wireless transceivers) and/or an interference type that corresponds to noise sources generating noise and interference in an environment or that is projected and/or communicated into an area around an intelligent umbrella and/or shading system. In embodiments, the noise and/or interference may be from natural sources (e.g., electromagnetic waves, sound waves, impulse waves), from mechanical devices, from acoustic devices, and/or other electronic devices (e.g., home security systems, other routers, wireless printers, wireless transmitters and/or receivers, and/or ICs). In embodiments, an interference sensor may have tolerance conditions established and may identify different type of noise and/or interference. In embodiments, an interference sensor may also able to measure and/or calculate a type of noise and/or interference, where a source may be located and how often the noise and/or interference may be detected and/or measured. In embodiments, an interference sensor may calculate signal measurements, signal strengths, and/or other conditions (e.g., is it repetitive and/or randomly occurring and is it based at least on other conditions associated with measured interference). In embodiments, an interference sensor may communicate signal measurements, signal strengths, other conditions and/or locations to a memory for storage. In embodiments, interference sensor signal measurements, strengths, conditions and/or distances may be communicated to a computing device 136 where one or more processors may execute computer-readable instructions to 1) receive interference sensor signal measurements, strength measurements, and/or conditions; and/or 2) process such measurements and/or conditions. In embodiments, one or more processors (e.g., in a computing device 136) in conjunction with computer-readable instructions executed by the one or more processors may generate commands, instructions, messages and/or signals to cause actions by other components and/or assemblies in response to measurements and/or conditions captured and/or received by an interference sensor. In embodiments, computer-readable instructions fetched from one or more memory modules and executed by a processor (e.g., of a computing device 136) may generate and communicate commands to a motion control board 134 (or other circuits or circuit assemblies) to cause different motor assemblies to move assemblies of an intelligent umbrella and/or shading system to different locations and/or positions. In embodiments, interference sensor measurements may identify that cellular communications may not be reliable in an area around an intelligent umbrella because of a high level of interference in a cellular communications frequency band and computer-readable instructions executable by one or more processors may communicate commands and/or signals to a cellular transceiver to deactivate a cellular transceiver 195. In embodiments, computer-readable instructions executable by a processor may also not communicate any commands, signals, instructions and/or messages to a cellular transceiver 195 until interference and/or noise conditions have improved. In embodiments, computer-readable instructions executed by a processor of a computing device 136 (or other processor/controller) may generate and communicate commands, messages, signals and/or instructions to a sound reproduction system (e.g., an audio receiver and/or speaker) to cause an alarm to be activated and/or a warning message to be reproduced and/or generate and communicate commands, messages, signals and/or instructions to a lighting system and/or sound communication system to generate lights and/or audible alerts indicating a dangerous or problematic situation is occurring or going to occur (e.g., high level of impulse noise or EMI). In addition, because high levels of different types of noise can impact performance of specific electrical components, an interference sensor's measurements, conditions and/or distances may be communicated to a processor and computer-readable instructions executed by one or more processors may generate and communicate commands to a power subsystem (e.g., a rechargeable battery and/or power charging assembly) to power to power off and/or deactivate components and/or assemblies susceptible to noise and/or interference. Advantages of having an interference sensor integrated within an intelligent umbrella and/or shading system 100 and/or attached, connected or coupled thereto, are that an interference sensor may identify problematic conditions, shut down portions of an intelligent umbrella and/or shading system in response thereto, and/or warn users of a potentially problematic and dangerous situation. In addition, an intelligent umbrella with an interference sensor may operate more efficiently by avoiding certain communication frequency bands having large levels of noise which could impact accuracy of wireless communications.

The claimed subject matter herein is directed to an outdoor umbrella, outdoor shading device outdoor parasol, outdoor shading system, outdoor voice-recognition modules and/or outdoor voice-activated hubs, and outdoor lighting elements that utilize the Controller Area Network (CAN) protocol to communicate between assemblies, devices, components and systems operated therein. It is important in a shading device, parasol or umbrella that a method exists to allow the various assemblies, components and/or devices within the shading device, parasol or umbrella to communicate without utilizing a host computing device. A host computing device or an integrated computing device may be present in the shading device, but is not required for different assemblies, components and/or devices to communicate data, measurements, parameters and/or information back and forth. This provides an advantage when adding new modules (or components, assemblies or devices) or removing modules because as long as the added components, assemblies or devices are CAN protocol compatible they may be communicated with. In addition, the use of the CAN protocol and bus may allow other processors and/or transceivers to be utilized for transferring audio data, video data and/or speech data. In addition, the use of the CAN bus and/or CAN protocol may result in fewer processors or controllers being utilized in a shading device because a smaller number of processors or controllers may be utilized to communicate commands, instructions, messages or signals to components, assemblies, and/or other devices. The claimed subject matter herein also applies to indoor umbrella, indoor parasol, indoor shading system, indoor voice-recognition modules and indoor voice-recognition hubs and indoor lighting elements that utilize the Controller Area Network (CAN) protocol to communicate between assemblies, devices, components and/or systems operated therein.

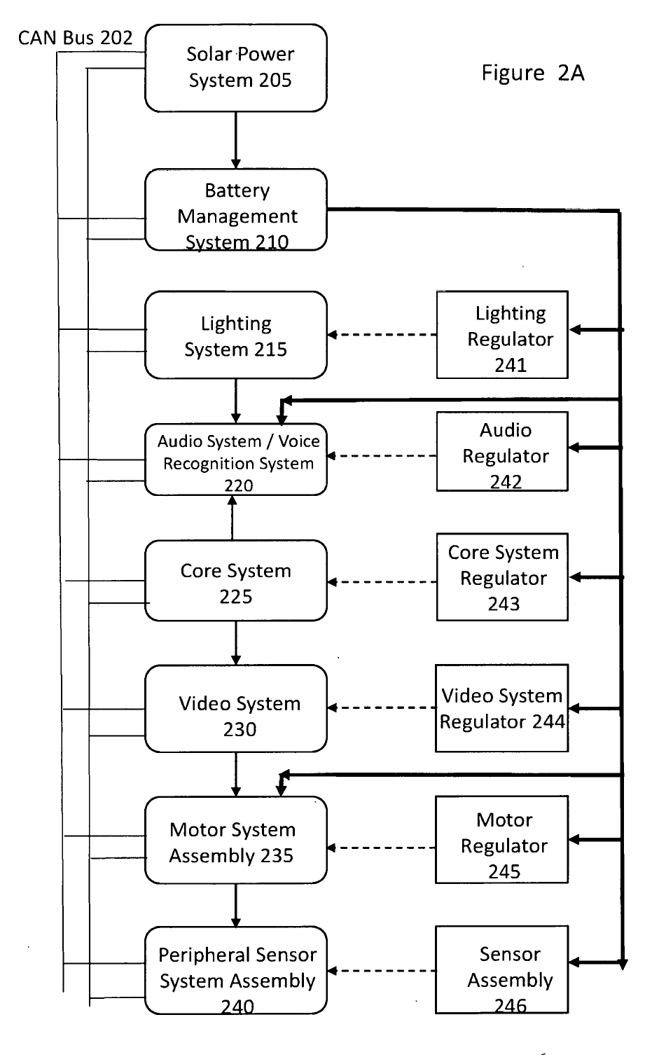

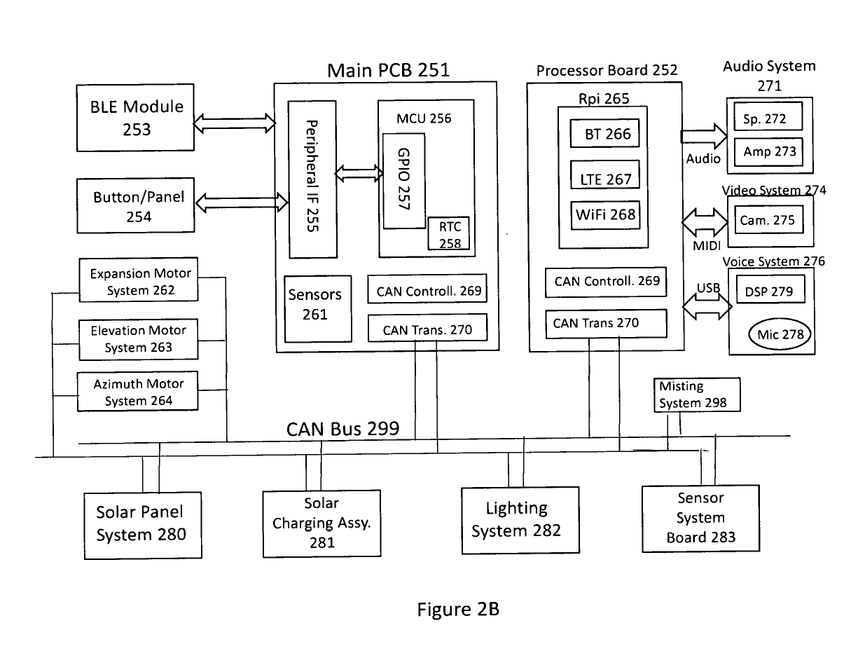

FIG. 2A illustrates a block diagram of power distribution via a CAN bus in a shading device. As discussed previously, a shading device may comprise an umbrella, a parasol, a shading system, a lighting assembly with a shade, a voice-activated outdoor hub, an outdoor umbrella, an outdoor parasol, an outdoor lighting assembly, and/or an outdoor shading system In embodiments, a shading device power distribution system 200 comprises a Controller Area Network (CAN) bus 202 with a number of connection nodes or edges, a solar power system 205, a battery management system 210 and/or one or more rechargeable batteries, one or more lighting systems 215 and one or more lighting system regulators 241, one or more audio systems or voice recognition systems 220 and associated one or more audio system regulators 242. In embodiments, a shading device power distribution system 200 may also comprise a core system 225 and one or more associated core system regulators 243, a video or image system 230 and one or more associated video or image system regulators 244, one or more motor assemblies 235 and one or more motor assembly regulators 245, and/or one or more peripheral sensor systems 240 and one or more sensor system regulators 246. In embodiments, a CAN bus 202 may be connected to a solar power system 205, a battery management system 210 and one or more rechargeable batteries one or more lighting systems 215, one or more audio systems or voice recognition systems 220, one or more core systems 225, one or more video systems 230, one or more motor assemblies 235 and/or one or more peripheral sensor systems 240. In embodiments, although only three motor assemblies may be shown in FIGS. 1A, 1B and 1C and FIG. 2A, a CAN bus 202 may be utilized to communicate commands, instructions, messages and/or signals to one, two or three motor assemblies, but also four or more motor assemblies. In embodiments, the CAN bus may be a serial bus for communicating data and/or control signals between the different components and assemblies described herein. In embodiments, different serial communication buses or bus protocols may be utilized to communicate between devices, components and/or assemblies. Alternative buses may be utilized such as FlexRay, Ethernet and/or I2C. A CAN bus 202 is part of a peer-to-peer network. This means that there is no master device that controls when individual nodes, assemblies or devices have access to read and write data on the CAN bus 202. When a CAN node (e.g., a core system 225) is ready to transmit data, the core system 225 may check to see if the CAN bus 202 is busy and then simply write a CAN frame onto the network including the CAN bus. The CAN frames that are transmitted do not contain addresses of either the transmitting node (e.g., a core system 225) or any of the intended receiving node(s) (e.g., one or more motor assemblies 235 or one or more peripheral sensor systems 240). In embodiments, the voltage converters and/or regulators (241, 242, 243, 244, 245, or 246) described above may be controller by one or more processors on a main circuit board (see 251 in FIG. 2B). In embodiments, the voltage converters and/or regulators (or a portion thereof) may be turned off or shut down when a shading device enters sleep mode.

In embodiments, a solar power system 205 may generate power (e.g., voltage and current) from sunlight in an outdoor environment. In embodiments, the solar power system 205 may transfer power to a battery in the battery management system 210. In embodiments, the battery in the battery management system 210 may provide voltage and/or current to a number of assemblies, modules, and/or components in the shading device. In embodiments, the power generated by the one or more batteries in the battery management system may be between 12 to 14 Volts direct current (DC). In embodiments, some of devices, assemblies or components require 12 to 14 volts DC whereas other devices, assemblies or components require 3.3 to 5 volts DC.

In embodiments, because some of the devices, assemblies or components require 3.3 to 5 volts DC, one or more voltage regulators 241 to 246 may be utilized to provide the 3.3 to 5 volts DC. In FIG. 2A, the provision of 3.3 to 5 volts is represented by dotted lines whereas the provision of 12 to 14 volts is represented by thick solid lines. In embodiments, the one or more lighting systems 215 requires a DC voltage power of 3.3 to 5 volts and thus, the one or more batteries in the battery management system 210 supply DC power (e.g., voltage and/or current) to a lighting system regulator 241. In embodiments, a lighting system regulator 241 supplies DC power to one or more lighting systems 215 to power the one or more lighting assemblies. In embodiments, instructions and/or data/information is communicated to the one or more lighting systems 215 via the CAN bus 202. In embodiments, instructions and/or measurements and/or status data or information is communicated from the one or more lighting systems 215 via the CAN bus 202. In embodiments, for example, one or more processors on an integrated computing device or processor board or one or more processors on a motor and sensor board may communicate instructions, commands or messages to/or from the one or more lighting systems 215 via the CAN bus 205.

In embodiments, some components or assemblies of the audio system/voice recognition module or system 220 may require 12 to 14 Volts DC and some component or assemblies may require 3.3 to 5 Volts DC. In embodiments, the one or more power buses 211 may provide the 12 to 14 Volts DC to 1) an audio regulator 242 and/or 2) an audio system/voice recognition system/software module 220. In embodiments, the one or more audio regulators 242 may receive the 12 to 14 Volts DC to between 3.3 to 5 Volts DC and supply the 3.3 to 5 Volts DC to the audio system/voice recognition system 220. In embodiments, instructions and/or measurements, status data and/or audio files may be communicated to and/or from the audio system/voice recognition system 220 via the CAN bus 202. In embodiments, for example, one or more processors on an integrated computing device or processor board or one or more transceivers on an integrated computing device or processor board may communicate instructions, commands or messages and/or audio data to/or from the one or more audio system/voice recognition system 220 via the CAN bus 202. In other words, some components or assemblies in the audio system/voice recognition system 220 may require 12 to 14 Volts DC and some components or assemblies may require 3.3 to 5V DC.

In embodiments, a core system 225 of an outdoor shading device may comprise an integrated computing device (or processor board) and/or a main board (e.g., mechanical and sensor board). In embodiments, components and/or assemblies of the core system 225 may require between 3.3 to 5 volts DC. In embodiments, the one or more batteries in the battery management system 210 may provide between 12 to 14 Volts DC to the core system regulator 243 and the core system regulator 243 may convert the 12 to 14 Volts DC to 3.3 to 5 Volts DC. In embodiments, the core system regulator 243 may supply the 3.3 to 5 volts DC to the components and/or assemblies of the core system 225

In embodiments, a video system 230 of an outdoor shading device may comprise one or more imaging devices. In embodiments, the components or assemblies of the video system 230 may require between 3.3 to 5 volts DC. In embodiments, the one or more batteries in the battery management system 210 may provide between 12 to 14 Volts DC to the video system regulator 244 and the core system regulator 244 may convert the 12 to 14 Volts DC to 3.3 to 5 Volts DC. In embodiments, the video system regulator 244 may supply the 3.3 to 5 volts DC to the components and/or assemblies of the video system 230.

In embodiments, a motor system assembly 235 may have some components and/or assemblies that require between 12 to 14 Volts DC and some components and/or assemblies that require between 3.3 to 5 volts DC. In embodiments, a motor system assembly 235 may include an expansion motor, an elevation motor and/or an azimuth motor. In embodiments, the one or more batteries in the battery management system 210 may provide 12 to 14 Volts DC power to one or more motor regulators 245. In embodiments, the one or more batteries in the battery management system 210 may supply or provide 12 to 14 Volts DC to the components and assemblies in the motor system assembly 235 that require such a voltage. In embodiments, the one or more motor regulators 245 may convert the received 12 to 14 Volts DC to 3.3 to 5 Volts DC and supply the 3.3 to 5 Volts DC to the components or assemblies of the motor system assembly 235. In embodiments, one or more processors may communicate commands, instructions and/or messages to the one or more motor system assemblies 235 via a CAN bus 202.

FIG. 2B illustrates a block diagram and data flow diagram of a shading device include a CAN bus according to embodiments. FIG. 2B illustrates how the CAN bus allows communications between most or all of the devices or components of the shading device. An important improvement to the shading device illustrated in FIG. 2B is the use of a BLE module 253 to communicate with external devices rather than and/or in addition to the use of the PAN transceiver 266, cellular transceiver 267 and/or 802.11 (wireless LAN) transceiver 268. In embodiments, the shading device illustrated in FIG. 2B comprises a main printed circuit board 251, a processor board 252, an audio system 271, a video system 274, and/or a voice recognition system 276. These systems may alternatively be installed on a number of circuit boards and/or physical devices. In embodiments, a shading device, as illustrated in FIG. 2B, comprises a sensor system board 283, a lighting system 282, a solar charging assembly 281, and/or a solar panel system 280. In embodiments, a shading device 200 comprises an expansion motor system 262, an elevation motor system 263, an azimuth motor system 264, a button and/or control panel 254 and/or a Bluetooth Low Energy (BLE) transceiver 253.

In embodiments, a main shading device printed circuit board 251 may comprise one or more microcontrollers or MCUs 256, one or more CAN controllers 269 and/or transceivers 270, one or more sensors 261, and/or one or more peripheral interface assembly or chipset 255. In embodiments, the MCU 256 may be a STM32 microcontroller and may include one or more static memory devices, one or more flash memory devices and/or one or more processors. In embodiments, the MCU 256 may comprise a real time clock 258 and a general purpose input/output (GPIO) 257. In embodiments, a GPIO 257 may comprise one or more pins which may interface with the one or more processors in the MCU (e.g., which may communicate interrupts to the processor). In embodiments, the one or more peripheral interface assembly or chipset 255 may communicate with the one or more GPIO 257 to transfer commands, messages and instructions to the one or more processors in the MCU 256. In embodiments, these command, instructions and/or messages may be communicated from the BLE module 253. In embodiments, these commands, instructions and/or messages may be communicated from the button or control panel 254. In embodiments, the peripheral interface assembly or chipset 255 may utilize a serial to parallel interface and may include an analog-to-digital converter. In embodiments, the button 254 may be an on-off button and/or an emergency shutdown switch that communicates with the MCU 256 through a GPIO 257 and/or the one or more peripheral interface assembly or chipset 255. In embodiments, the control panel may include one or more buttons that provide different commands, instructions or messages. These buttons, for example, may be used to activate or utilize the lighting system 282, the camera system 275, the audio system 271, the azimuth motor system 264 to rotate the shading device, the elevation motor system 263 to tilt the shading device, or the expansion motor system 262 to open or close the shading arms or blades on the shading device. In embodiments, these buttons, for example, may be used to activate the voice system 276 (e.g., via voice recognition).

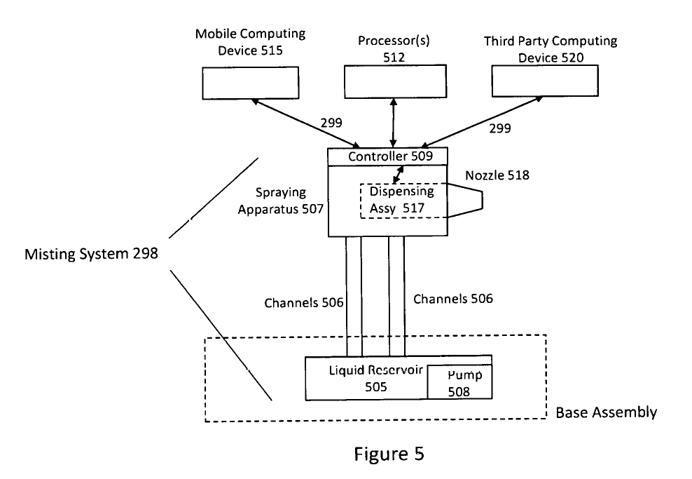

In embodiments, the shading device may comprise a misting system 298. FIG. 5 illustrates a block diagram of a misting system in a shading device according to embodiments. In embodiments, a misting system 298 may comprise a liquid reservoir 505 and one or more channels 506 to deliver to liquid to a spraying apparatus 507. In embodiments, the misting system 298 may further comprise a pump 508 to pump the liquid out of the reservoir 505 through the one or more channels 506 to the spraying apparatus 507. In embodiments, a controller 509 may receive commands, instructions and/or signals from, for example, a CAN bus 299. In embodiments, a controller 509 may generate signals or commands to the spraying apparatus 507 to spray certain mists or misting patterns and/or at certain frequencies. In embodiments, a spraying apparatus 507 may comprise a dispensing assembly 517 to a nozzle 518. In embodiments, a controller 509 may generate signals or commands in to the pump 508 to pump water from, for example, a base of the shading device, through the one or more channels 506 to a spraying or misting apparatus 507 (which includes a dispensing assembly 517 to a nozzle 518. In embodiments, the controller 509 and/or the CAN bus 299 may receive commands, instructions, messages and/or signals from 1) one or more of the processors 512 in the shading device; and 2) an external computing device such as a mobile computing device 515 which communicates via, for example, a BLE module or transceiver 253; or a third party computing device 520. In embodiments, the controller 509 and/or the CAN bus 299 via voice commands that are received at the shading device 500, the mobile communications device 515 and/or at a third party computing device 520 (e.g., such as in an IoT application).

In embodiments, the main circuit board 251 may comprise a CAN controller 269 and a CAN transceiver 270 which are utilized by the MCU 256 to communicate with other components, assemblies and/or devices (e.g., the motor systems, the solar charging assembly, the lighting system and/or one or more sensors). In other words, computer-readable instructions stored in the one or more memory devices of the MCU 256 may be executable by one or more processors in the MCU to communicate commands, instructions, messages or signals to the motor systems, solar charging assembly, lighting system or sensors/sensor assemblies and to receive (from such assemblies, devices or components), messages, parameters, measurements and/or signals. In other words, for example, the MCU may activate or deactivate the azimuth motor system, the elevation motor system, the expansion motor system, the lighting system, the solar charging assembly, and/or any of the weather condition sensors, or any of the detection sensors or directional measurement sensors and also receive status indicators and/or parameters or measurements from the same assemblies and/or devices. In embodiments, this information may be measurements or status indicators from one or more sensors or sensor assemblies on the sensor system board 283, status indicators or messages from a solar charging assembly, a lighting system 282 and/or more one or more motor systems 262 263 264. In embodiments, one or more processors on the MCU 256 may receive commands, instructions, messages or signals from the BLE module 253 and may communicate with other devices, systems, components or assemblies via the CAN controller 269 and CAN transceiver 270. In other embodiments, a BLE module 253 may communicate these commands, instructions, messages or signals directly to a CAN controller 269 and CAN transceiver 270.

In embodiments, the weather or environment sensors may be air quality sensors, UV radiation sensors, light sensors, humidity sensors, temperature sensors, gas sensors, wind sensors, methane sensors, radiation sensors, carbon monoxide sensors, lightning sensors, and/or carbon dioxide sensors. In embodiments, a directional or location sensor may be a GPSS transceiver, a digital barometer, and/or a digital compass. In embodiments, other sensors may be noise sensors, radiation sensors, and/or wireless interference sensors. In embodiments, movement sensors may be accelerometers, gyroscopes, magnetometers, proximity sensors, motion detection sensors and/or laser sensors. In embodiments, the main PCB 251 may have sensors such as movement sensors, noise sensors, radiation sensors or interference sensors installed thereon. In embodiments, the MCU (e.g., computer-readable instructions executable by one or more processors of the MCU) 256 may communicate with these sensors and receive measurements, parameters and/or information from these sensors.

The shading device may also comprise a processor printed circuit board 252. In embodiments, the processor printed circuit board may comprise a single-board computer such as a Raspberry Pi and/or a system on a Chip (SoC). In embodiments, a SoC may be, for example, a Libre chip. In embodiments, a single board computer or SoC may comprise one or more processors, one or more static memory devices, one or more dynamic memory devices, one or more input/output ports (e.g., USB, etc.), a wireless network transceiver (e.g., 802.11 or WiFi transceiver) 268, a personal area network transceiver (e.g., Bluetooth or Zigbee) 266, and/or a cellular transceiver 267. In embodiments, this may allow the shading device to communicate information and/or data to external computing devices in a number of different ways and prevents failure of one of the transceivers (or failures of remote computing devices communicating with the shading device) from hindering or shutting down communications operation of the shading device. In embodiments, the processor board 252 may further comprise a CAN controller 269 and/or a CAN transceiver 270 to translate commands, messages, instructions and/or signals from the one or more processors of the single-board computer or SoC to various components, assemblies or devices (e.g., a solar charging assembly 281, a lighting system 282, weather sensors 283, directional sensors (or movement sensors or detection sensors 261). In embodiments, the CAN controller 269 and the CAN transceiver 270 on the processor board 252 may communicate with the CAN controller 269 and CAN transceiver 270 on the main PCB 251 in order to communicate messages, instructions, commands and/or signals generated by the one or more processors of the processor PCB 252 to the one or more motor systems 262 263 264. In embodiments, the processor board 252 may communicate directly with one of the motor systems 262 263 264 via the CAN bus 299 (e.g., using its CAN controller 269 or CAN transceiver 270) or may communicate indirectly with the motor systems utilizing another processor or PCB (e.g., main PCB 251) and the CAN bus 299 (via its CAN controller 269 and/or CAN transceiver 270).

In embodiments, the processor board 252 may communicate with the audio system 271 to communicate audio files (e.g., analog or digital music files or voice files) to the audio system for reproduction and playback. In embodiments, the audio system 271 may comprise a speaker 272 and an amplifier 273, where the audio system 271 may receive the communicated audio file(s), amplify the audio files via the amplifier 273, and communicate the amplified audio signals to the speaker for playback. In embodiments, an audio system 271 may further comprise a woofer, a subwoofer, and/or a passive radiator.

In embodiments, the processor board 252 (e.g., one or more of the processors on the processor board) may communicate with one or more cameras 275 in a video system 275. In embodiments, the one or more cameras 275 may be mechanically adjustable utilizing gimbals in order to change an angle of the camera lens and the ability to capture images of different views in an area surrounding the shading device. In embodiments, the one or more cameras may communicate with one or more processors in, for example, the processor printed circuit board 252 via a Mobile Industry Processor Interface (MIPI) interface. In embodiments, other video or image interfaces and/or protocols may be utilized. In embodiments, the one or more cameras 275 may communicate images or videos, and associated parameters and/or measurements to the one or more processors on the processor printed circuit board 252. In embodiments, one or more of the PAN transceivers 266 (e.g., Bluetooth), the cellular transceivers 267 (e.g., LTE) and/or the WiFi transceivers 267 may then communicate the received images or videos (and associated parameters and/or measurements to external computing devices). In embodiments, the one or more cameras 275 may comprise one or more microphones and then the one or more cameras may then also communicate one or more audio files associated with the images and/or videos via the MIPI interface (or other similar interface) to one or more processors on the processor board 252. In embodiments, the one or more cameras 275 may communicate images or videos (and associated parameters and/or measurements) to external computing devices via a BLE module 253 in some circumstances (either directly or indirectly (through the one or more processors or transceivers on the processor PCB 252).

In embodiments, a shading device 275 may comprise a voice system 276. In embodiments, a voice system 276 allows individuals with disabilities to communicate with and/or control a shading device. In embodiments, a voice system 276 may comprise one or more digital signal processors 279 and/or one or more microphones 278. In embodiments, a user or operator make generate or speak voice commands which are captured by the one or more microphones 278. In embodiments, the one or more microphones 278 may be positioned or installed as part of an array of microphones that capture sounds or audio from multiple directions around the shading device. For example, a microphone array may be installed on a ring around the shading device where the microphones are placed at 90 degrees from each other so that sounds or commands may be captured from all directions around a shading device. In embodiments, sounds or voice commands captured by the one or more microphones 278 may be transferred to the one or more DSPs 279 which the sounds or voice commands are converted into one or more audio files. In embodiments, the one or more DSPs 279 may also filter noise and/or interference from the one or more audio files. In embodiments, the one or more audio files may be communicated from the one or more DSPs 279 to the one or more processors on, for example, the processor board 252. In embodiments, the one or more processors on, for example, on the processor board 252 may communicate the captured one or more audio files to external computing devices for, for example, voice recognition, utilizing one or more of the PAN transceiver 266, cellular transceiver 267 or wireless LAN transceiver 268. In other words, external voice recognition systems or engines may perform the voice recognition which is then communicated back to the shading device in order for the shading device operations to be performed (open or close shading device, rotate shading device, etc). In embodiments, the one or more processors on the processor board 252 may communicate the audio files to an external computing device via the BLE module 253. In embodiments, computer-readable instructions stored on memory devices on the processor board 252 may be executable by one or more processors of the single board computing device or SoC 265 to perform voice recognition locally on the shading device. In other words, the voice recognition may be performed locally. In embodiments, any commands, instructions, messages and/or signals generated from the voice commands may be communicated to other assemblies, components or devices within the shading device (e.g., lighting system 282; position sensors, directional sensors, weather sensors, interference or noise sensors 261 or 283; solar charging assemblies 281 and/or motor systems 262 (expansion), 263 (elevation), or 264 (azimuth).

In embodiments, a shading device may comprise one or more sensor system boards 283. In embodiments, certain sensors may be located on the sensor system board 283. In embodiments, weather or environment sensors such as lightning sensors, humidity sensors, temperature sensors, air quality sensors, carbon monoxide sensors, radiation sensors, carbon dioxide sensors, and/or ultraviolet sensors may be located on a sensor system board 283. In embodiments, the sensor system board 283 may be encased in an enclosure that has a clear surface in order to allow the sensors to obtain measurements easier due to a skin or outer surface being in the way. In embodiments, a proximity sensor, a motion sensor or a laser sensor may also be installed or positioned on a sensor system board 283. In embodiments, the sensor system board 283 may be located on a top portion of the shading device. In embodiments, one or more processors on the main processor board 252 and/or one or more processors on the main board 251 may communicate commands, instructions, messages and/or signals to the sensor system board 283 via the CAN bus 299 (e.g., utilizing a CAN controller 269 and/or CAN transceiver 270). In embodiments, a mobile communication device may communicate commands, instructions, messages and/or signals to sensors on the sensor system board in order to obtain parameters, measurements, and/or information from the one or more sensors on the sensor system board 283 utilizing a BLE module 253 (and/or processors on the main PCB 251). In addition, the mobile communication device may communicate commands, instructions, messages and/or signals to the sensor system board 283 via a PAN transceiver 266, a cellular transceiver 267, and/or a wireless LAN transceiver 268.

In embodiments, a shading device may comprise a BLE Module 253. In embodiments, mobile communications or computing device may desire to communicate with a shading device 200. In embodiments, however, because the shading device is operating via one or more rechargeable batteries and/or solar power, it is vital to conserve power as much as possible. The BLE module 253 is a Bluetooth Low Energy device that utilizes less power than normal. In embodiments, the shading device may only have a BLE module 253 powered initially in order to save power and once a BLE module 253 receives commands, instructions or messages from a mobile computing or communications device, instructions or commands are communicated to other devices, assemblies or components to power on or activate. In embodiments, the BLE module 253 may be a system on a chip (SoC) such as a Nordic semiconductor device that is able to pair and/or communicate with other Bluetooth or PAN transceivers, such as in mobile computing devices, in order to engage in bi-directional communications. Other semiconductors and/or chipsets may be utilized as BLE modules 253. In other words, a shading device may be in sleep mode or powered off except for a BLE module 253. In embodiments, once the BLE module 253 receives a communication from an external computing device, computer-readable instructions executable by one or more processors on the BLE module may communicate messages, commands, instructions or signals to other components and/or assemblies on the computing device to activate these other components, assemblies, devices and/or systems. In embodiments, when a shading device is in sleep mode, the solar panel subsystem 280 may still be operational along with a solar charging assembly 281 and/or rechargeable battery in order to charge the rechargeable batter and obtain power for the system.

In embodiments, shading device mobile application software such as SMARTSHADE may communicate with a shading device utilizing the BLE module 253 in the shading device. In embodiments, a mobile computing/communications device (running and executing shading device mobile application software) may communicate with the shading device utilizing its Bluetooth transceiver. This is an advantage because no local area network, WiFi or cellular connectivity is needed in order for the mobile computing/communications device to communicate with the shading device. In addition, unlike remote controls devices, the BLE module 253 allows for bidirectional communication between the mobile computing/communications device and the shading device. In embodiments, the mobile computing/communications device (running and executing shading device mobile application software) may control basic and fundamental functions of the robotic shading device such as interacting with the elevation motor assembly, the azimuth motor assembly and/or the expansion motor assembly, as well as interacting with the real-time clock, the lighting assembly, the environmental sensors, the directional sensors, the detection sensors and/or the weather sensors. Because the BLE module 253 is low power consumption, the power utilized in communications is minimized in comparison to utilizing WiFi, cellular or even standard Bluetooth protocols for communications between the mobile computing device and/or the shading device. In embodiments, the mobile computing/communications device may communicate commands, instructions and/or messages to the BLE module 253 which may in turn communicate the received commands, instructions, messages or signals to the main PCB (e.g., one or more processors in the MCU 256). In embodiments, computer-readable instructions executed by the MCU 256 may then communicate the commands, messages and/or instructions to the other assemblies, device or components utilizing the CAN bus 299. In embodiments, the mobile computing/communications device may communicate commands, instructions and/or messages to the BLE module 253 which may in turn communicate the received commands, instructions, messages or signals to the processor PCB (e.g., one or more processors in the single-board computer or SoC), which may then communicate the received commands, messages and/or instructions to the other assemblies, devices and/or components utilizing the CAN bus 299. In embodiments, the assemblies, components, devices and/or systems of the shading device may communicate measurements, status indicators, and/or values back to the mobile computing device via the BLE module 253. This may occur directly through the BLE module 253 or indirectly via the CAN bus 299 (and CAN transceivers 269 and/or CAN controllers 270) installed within the shading device.

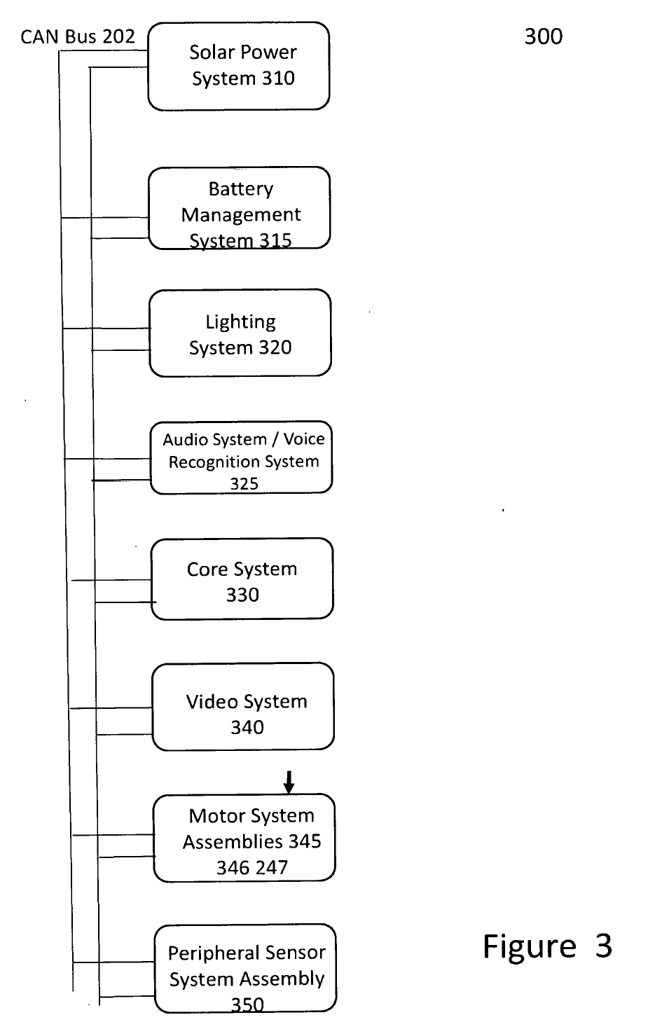

FIG. 3 illustrates a logical structural block diagram of a shading device according to embodiments. In embodiments, a shading device 300 may comprise a solar power system 310, a battery management system 315, a lighting system 320, an audio system 325, a core system 330, a video system or camera 340, one or more motor systems 345 346 347 and/or one or more sensors or sensor assemblies 350. In embodiments, the solar power system 310 may comprise a solar panel array. In embodiments, the solar panel array may generate 24 volts and/or between 60 to 80 watts. In embodiments, the battery management system 315 may comprise a device such as a solar charging and/or monitoring assembly. In embodiments, a solar charging and/or monitoring assembly may control charging of a rechargeable battery, may monitor voltage and/or current generation, may monitor power generation and/or may monitor power consumption from assemblies, motors and/or components. In embodiments, a lighting assembly 320 may comprise a red, green, blue and/or white (RGBW) LED lighting assembly. In embodiments, a RGBW LED lighting assembly may be a lighting strip and/or may be a lighting tape. In embodiments, a lighting assembly may also include a lighting controller to receive signals, commands, instructions or messages from another processor or controller to control activation, intensity and/or selection of LEDs within the lighting assemblies. In embodiments, a lighting assembly may also comprise a converter, which may convert 12V to 5V and may be a buck converter. In embodiments, output current of the lighting controller may be greater than 4 Amps.

In embodiments, a shading device may also comprise an audio system 325. In embodiments, an audio system 325 may comprise one or more amplifiers, one or more radiators, and/or one or more speakers. In embodiments, an audio system 325 may comprise one or more microphones and/or a voice recognition module or engine to perform voice recognition on audible commands captured by the one or more microphones. In embodiments, the voice recognition engine or module may perform the voice recognition within the shading device and generate text commands or instructions that are utilized by the one or more processors to perform actions on assemblies or components. In embodiments, the voice recognition engine or module may communicate the captured audio files to a remote voice recognition server or computing device (e.g., located in the cloud or another remote location) to perform voice recognition and may receive commands, instructions and/or messages (which may be text) back from the voice recognition server or computing device. In embodiments, a shading device may also comprise a core system 330. In embodiments, a core system 330 may include a Bluetooth Low Energy (“BLE”) transceiver; one or more wireless communication transceivers (e.g., PAN transceiver, cellular transceiver, wireless LAN (e.g., WiFi or 802.11) transceiver); one or more processors that control operations of components, assemblies and/or devices of the shading device; and one or more power consumption control devices. In embodiments, a shading device may comprise a video system 340. In embodiments, a video system 340 may comprise one or more digital cameras and/or HD cameras to capture images and/or video from around the one or more shading devices.

In embodiments, a shading device may comprise one or more motor systems 345 346 or 347 (e.g., an azimuth motor system 345; an elevation motor system 346; and/or an expansion motor system 347). In embodiments, the one or more motor systems 345 346 or 347 may control operations of the one or more motor assemblies (an azimuth motor, an elevation motor, and an expansion motor). The one or more motor systems 345 346 or 347 may also include Proportional-Integral-Derivative (PID) control. In embodiments, the one or more motor systems 345 346 or 347 may also include emergency stop circuitry or functionality and/or may also include current and/or voltage limiting assemblies or circuitry. In embodiments, the one or more shading devices may comprise one or more peripheral sensor system assemblies 350. In embodiments, the peripheral sensor system assemblies 350 may comprise or include serial and/or parallel input or output controllers that collect data, parameters or measurements from one or more sensors. In embodiments, the one or more shading devices may include serial and/or parallel input or output controllers that generate interrupt signals that are communicated to the one or more processors in the core system 330.

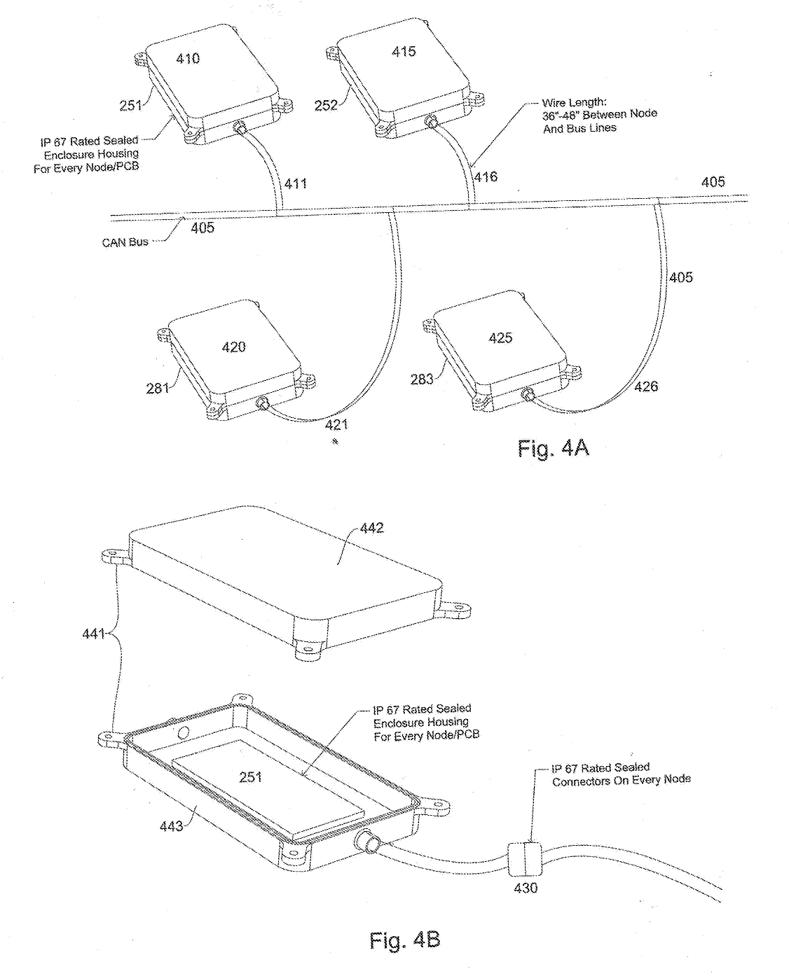

FIG. 4A illustrates a mechanical view of a shading system including a plurality of physical enclosures connected or coupled via a Controller Area Network (CAN) bus according to embodiments. FIG. 4B illustrates a physical enclosure housing a component, system, assembly, device or printed circuit board according to embodiments. Inside a shading device, a CAN bus 405 may connect a plurality of printed circuit boards or nodes. In embodiments, as illustrated in FIG. 4A, the shading device of FIG. 2B may have a number of boards or assemblies housed in enclosures. In embodiments, a main PCB 251 may be housed and/or resident in a first enclosure 410; a processor PCB 252 may be housed and/or resident in a second enclosure 415; portions of a solar charging assembly 281 may be housed and/or resident in a third enclosure 420 and/or portions of a sensor system board 283 may be housed in a fourth enclosure 425. In embodiments, the enclosures 410 415 420 and 425 may protect components of the PCBs or assemblies from dust and also may be water resistant. In embodiments, the enclosures 410 415 420 and 425 may be IP 67 rated which means the enclosures are full protected from dust and/or other contaminants and can withstand being subjected and/or submerged in 3.3 feet of water for up to 30 minutes. This is important in a shading device which is outside and may be subject to harsh weather conditions such as rain, wind, hail, humidity, smoke and/or air contaminants. In embodiments, as shown in FIG. 4A, wires or cables 411, 416 421 and 426 connect the respective enclosures 410 415 420 and 425 to the CAN bus 405. In embodiments, the wire length for wires 411 416 421 and 426 may be between 12 inches and 48 inches in length. In embodiments, the wires 411 416 421 and 426 may have sealed connectors (e.g., see connector 430) to provide additional protection. In embodiments, an enclosure (e.g., enclosure 441) may include a top portion 442 and a bottom portion 443 that are sealed and/or connected by fasteners, connectors and/or adhesives. In embodiments, the bottom portion 443 may have a printed circuit board, assembly, component or system installed within. FIG. 4B illustrates a printed circuit board (e.g., main PCB 251) installed within the bottom portion of the enclosure 441 having a top portion 442 or a bottom potion 443.

In embodiments, a shading device may have one or more sensors. In embodiments, sensors may include environmental sensors, directional sensors and/or proximity sensors. In embodiments, environmental sensors may include lightning sensors, wind sensor, barometric pressure sensors, humidity sensor, air quality sensor, carbon dioxide or carbon monoxide sensor and/or ultraviolet sensors.

In embodiments, an integrated computing device may store and/or execute shading object or umbrella application software, which may be referred to as SMARTSHADE and/or SHADECRAFT application software. In embodiments, shading object or umbrella application software may be run and/or executed on a variety of computing devices including a computing device integrated within a shading object or umbrella. In embodiments, for example, shading object or modular umbrella application software may include computer-readable instructions being stored in non-volatile memories of a computing device, a portable electronic device (e.g., a smart phone and/or a tablet), an application server, and/or a web application server, all which interact and communicate with each other. In embodiments, computer-readable instructions may be retrieved from memories (e.g., non-volatile memories) of these above-identified computing devices, loaded into volatile memories and executed by processors in the computing device, portable electronic device, application server, and/or mobile application server. In embodiments, a user interface (and/or graphical user interface) for a modular umbrella software application may be presented on a portable electronic device, although other computing devices could also execute instructions and present a graphical user interface (e.g., dashboard) to an individual. In embodiments, modular umbrella application software may generate and/or display a dashboard with different application (e.g., process) selections (e.g., weather, health, storage, energy, security processes and/or application processes). In embodiments, modular umbrella application software may control operation of a modular umbrella, communicate with and receive communications from modular umbrella assemblies and/or components, analyze information obtained by assemblies and/or components of a modular umbrella, integrate with existing home and/or commercial software systems, and/or store personal data generated by the modular umbrella, and communicate with external devices.

In embodiments, a portable electronic device may also comprise a mobile application stored in a non-volatile memory. In embodiments, a mobile application may be referred to as a SHADECRAFT or a SMARTSHADE mobile application. In embodiments, a mobile application (mobile app) may comprise instructions stored in a non-volatile memory of a portable electronic device, which can be executed by a processor of a portable electronic device to perform specific functionality. In embodiments, this functionality may be controlling of, interacting with, and/or communicating with a shading object. In embodiments, mobile apps may provide users with similar services to those accessed and may be individual software units with limited or specific function. In embodiments, applications may be available for download from mobile application stores, such as Apple's App Store. In embodiments, mobile apps may be known as an app, a Web app, an online app, an iPhone app or a smartphone app. In embodiments, a sensor device (or other IoT device) may communicate to a server computing device via a cellular communications network, a wireless communication network, a wired communication network and/or other communication network. In embodiments, a sensor device and/or assembly device may capture sensor measurements, data and/or conditions and may communicate sensor measurements, data and/or conditions to an IoT enabled server, which may analyze, store, route, process and/or communicate such sensor measurements, data and/or conditions. In embodiments, an Internet of Things (IoT) may be a network of physical objects—sensors, devices, vehicles, buildings, and other electronic devices. In embodiments, the IoT may sense and/or control objects across existing wireless communication network infrastructure, an existing cellular communication network, and/or a global communications network infrastructure. In embodiments, integrating of devices via IoT may create opportunities for more direct integration of a physical world into computer-based systems, which may result in improved efficiency, accuracy and economic benefit. In addition, when an IoT device or server is augmented with sensors and actuators, IoT may be integrated or enabled with a more general class of cyber-physical systems, e.g., smart grids, smart homes, intelligent transportation and smart cities. In embodiments, in IoT, for example, may be uniquely identifiable through its embedded computing system but is able to interoperate within the existing Internet infrastructure. In embodiments, a device may have a specific IP address in order to be addressed by other IoT enabled systems and/or devices.

In embodiments, an IP address may be provided and/or established by routers and/or Internet service providers. For example, a modular umbrella enabled with IoT capability, because it may incorporate cameras, may be able to communicate with or be integrated into a home or office security system. Further, if an individual has a smart home, an individual may be able to control operation of, or communicate with a modular umbrella shading system as part of an existing smart home software application (either via a smart phone, mobile communication device, tablet, and/or computer). In addition, a modular umbrella shading system, if part of IoT, may be able to interface with, communicate with and interact with an existing home security system. Likewise, a modular umbrella shading system may be able to be an additional sound reproduction device (e.g., via speaker(s)) for a home audio and/or video system that is also on the IoT. In addition, a modular umbrella system may be able to integrate itself with an electronic calendar (stored on a computing device) and become part of a notification or alarm system because it will identify when upcoming meetings are occurring.

In embodiments, a modular umbrella system may be a device on an Internet of Things (IoT). In embodiments, an IoT-enabled device may be one or more cameras, one or more environmental sensors, one or more directional sensors, one or more movement sensors, one or more motor assemblies, one or more lighting assemblies and/or one or more solar panels or cells. These objects and/or IoT-enabled devices may comprise items and/or device may be embedded with electronics, software, sensors, and network connectivity, which enables these physical objects to detect, collect, process and/or exchange data with each other and/or with computing devices, Shadecraft IoT-enabled servers, and/or third-party IoT enabled servers connected to a modular umbrella system via a global communications network (e.g., an Internet).

In embodiments, IoT devices (e.g., servers, sensors, appliances, motor assemblies, outdoor shading systems, cameras, lighting assemblies, microphones, computing devices, etc.) may communicate with each other utilizing an Internet Protocol Suite. In embodiments, IoT devices may be assigned an IP address and may utilize IPv6 communication protocol. In embodiments where security is important, authentication may be established utilizing OAUTH (e.g., version 2.0) and Open ID Connect protocols (e.g., version 1.0). In addition, in embodiments, the IEEE 802.15.4 radio standard may allow for reduction in power consumption by IoT devices utilizing RF communications. In embodiments where power consumption may need to be decreased, e.g., as in sensors, modular umbrella shading systems, shading systems, cameras, processors), communication with IoT devices may utilize Message Queuing Telemetry Transport (MQTT) which utilizes TCP for its transport layer and utilizes a central MQTT broker to manage and/or route messages among a MQTT network's nodes. In embodiments, communication with IoT devices may utilize Constrained Application Protocol (CoAP) which utilizes UDP as its transport protocol. In embodiments, CoAP may be a client/server protocol and allows a one-to-one report/request instruction model. In embodiments, CoAP also may have accommodations for multi-cast transmission of messages (e.g., one-to-many report/request instruction model).

Non-volatile storage medium/media is a computer readable storage medium(s) that can be used to store software and data, e.g., an operating system, system programs, device drivers, and one or more application programs, in a computing device or one or more memory devices of a balcony shading and power system processor, controller and/or computing device. Persistent storage medium/media also be used to store device drivers, (such as one or more of a digital camera driver, motor drivers, speaker drivers, scanner driver, or other hardware device drivers), web pages, content files, metadata, playlists, data captured from one or more assemblies or components (e.g., sensors, cameras, motor assemblies, microphones, audio and/or video reproduction systems) and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in a balcony shading and power system controller may include or may execute a variety of possible applications, such as a software applications enabling communication with other devices, such as communicating one or more messages such as via email, short message service (SMS), or multimedia message service (MMS), FTP, or other file sharing programs, including via a network, such as a social network, including, for example, Facebook, LinkedIn, Twitter, Flickr, or Google+ and/or Instagram provide only a few possible examples. A computing device or a processor or controller in a balcony shading and power system may also include or execute an application to communicate content, such as, for example, textual content, multimedia content, or the like. A computing device or a processor or controller in a balcony shading and power system may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in a balcony shading and power system and/or mobile computing device may also include imaging software applications for capturing, processing, modifying and transmitting image, video and/or sound files utilizing the optical device (e.g., camera, scanner, optical reader) within a mobile computing device and/or a balcony shading and power system.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, DRAM, DDRAM, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. A shading device, comprising:
a base assembly, a bottom surface of a base assembly resting on a ground surface;
a support assembly, the support assembly coupled to a top portion of the base assembly;
an expansion assembly, the expansion assembly coupled to the support assembly; the expansion assembly to expand one or more arms to an open position or to retract the one or more arms to a closed position;
a Bluetooth Low Energy (BLE) transceiver to receive commands or messages from a mobile computing device to communicate with one or more assemblies of the shading device;
one or more Controller Area Network (CAN) transceivers;
a CAN bus to couple the one or more CAN transceivers to the one or more assemblies;
one or more memory devices;
one or more processors; and
computer-readable instructions executable by the one or more processors to:
communicate the commands or messages received from the BLE transceiver to the one or more CAN transceivers; and
communicate the commands or messages received from the CAN transceivers to the CAN bus and to communicate with the one or more assemblies.

2. The shading device of claim 1, the one or more assemblies comprising an azimuth motor assembly, an elevation motor assembly or an expansion motor assembly.

3. The shading device of claim 1, the one or more assemblies comprising one or more lighting assemblies.

4. The shading device of claim 1, the one or more assemblies comprising a solar charging assembly.

5. The shading device of claim 1, the one or more assemblies comprising one or more weather sensors.

6. The shading device of claim 1, the one or more assemblies comprising one or more positioning or directional sensors.

7. The shading device of claim 1, the one or more assemblies comprising detection sensors.

8. The shading device of claim 1, the one or more assemblies comprising one or more air monitoring sensors.

9. The shading device of claim 1, further comprising one or more microphones and one or more digital signal processors (DSPs), the one or more microphones to capture audio commands and the one or more DSPs to convert the captured audio commands to one or more audio files.

10. The shading device of claim 9, further comprising a wireless LAN transceiver or a wireless cellular transceiver, and
the computer-readable instructions executable by the one or more processors to communicate the audio files to an external computing device and to receive instructions, commands or messages from the external computing device to utilize the wireless LAN transceiver or the wireless cellular transceiver.

11. The shading device of claim 10, further comprising an additional CAN transceiver and
the computer-readable instructions executable by the one or more processors to communicate the received instructions or commands to the one or more assemblies via the additional CAN transceiver and the CAN bus.

12. The shading device of claim 1, further comprising one or more cameras to capture images or videos from an area around the shading device and to communicate the captured images or videos.

13. The shading device of claim 12, further comprising a wireless LAN transceiver or a wireless cellular transceiver, and
the computer-readable instructions executable by the one or more processors to communicate the captured images or videos to an external computing device via the wireless LAN transceiver or the wireless cellular transceiver.

14. The shading device of claim 13, wherein the external computing device is the mobile computing device.

15. The shading device of claim 12, the computer-readable instructions executable by the one or more processors to store a portion of the captured images or videos in the one or more memory devices of the shading device.

16. The shading device of claim 1, further comprising an audio system.

17. The shading device of claim 16, further comprising an additional personal area network (PAN) transceiver in addition to the BLE transceiver.

18. The shading device of claim 17, the additional PAN transceiver to receive music files from an external computing device, the computer-readable instructions executable by the one or more processors to communicate the received music files to the audio system for playback.

19. A shading device, comprising:
a base assembly, a bottom surface of a base assembly resting on a ground surface;
a support assembly, the support assembly coupled to a top portion of the base assembly;
an expansion assembly, the expansion assembly coupled to the support assembly; the expansion assembly to expand one or more arms to an open position or to retract the one or more arms to a closed position;
a Bluetooth Low Energy (BLE) transceiver to receive commands or messages from a mobile computing device to activate one or more assemblies of the shading device;
one or more Controller Area Network (CAN) transceivers;
a CAN bus to couple the one or more CAN transceivers to the one or more assemblies;
one or more memory devices;
one or more processors; and
computer-readable instructions executable by the one or more processors to:
communicate the commands or messages received from the BLE transceiver to the one or more CAN transceivers; and
communicate the commands or messages received from the CAN transceivers to the CAN bus and to the one or more assemblies or systems of the shading device;
a solar power system to generate voltage and/or current from an array of solar cells;
a battery management system to receive the generated voltage and/or current from the solar power system, to generate a first DC voltage range, to transfer the first DC voltage range to one or more of the assemblies or systems of the shading device and to transfer the first DC voltage range to one or more voltage regulators of the shading device,
wherein the one or more voltage regulators to generate a second DC voltage range and to transfer the second DC voltage range to one or more systems or assemblies of the shading device.
